(19) United States
(12) Patent Application Publication
(10) Pub. No.: US 2014/0132493 A1
(43) Pub. Date: May 15, 2014

(54) Clock Driver of Liquid Crystal Display

(71) Applicant: Shenzhen china Star Optoelectronics Technology Co. LTD., Shenzhen City, (CN)

(72) Inventors: Dongguang Wu, Shenzhen City (CN); Dengxia Zhao, Shenzhen City (CN)

(73) Assignee: Shenzhen China Star Optoelectronics Technology Co., LTD, Shenzhen City, Guangdong Province (CN)

(21) Appl. No.: 13/806,774

(22) PCT Filed: Nov. 25, 2012
(86) PCT No.: PCT/CN2012/085227

§ 371 Date: Dec. 22, 2012

(30) Foreign Application Priority Data
Nov. 15, 2012 (CN) 201210460605.X

(51) Int. Cl. G09G 3/36

(52) U.S. Cl. CPC G09G 3/36
USPC 345/87

(57) ABSTRACT

The present invention provides a clock driver of a liquid crystal display, including a primary timing control chip, a secondary timing control chip, display driving ports, a backlight driving port, a first storage device, a second storage device, and a data input port. The display driving ports are electrically connected to a liquid crystal panel. The backlight driving port is electrically connected to the backlight driving circuit. The primary and secondary timing control chips receive a control signal from the data input port and supply a display timing control signal and a display data signal via the display driving port to the liquid crystal panel according to the control signal. Further, the secondary timing control chip outputs, via the backlight driving port, a pulse width modulation signal to the backlight driving circuit. The clock driver uses two timing control chips to drive the liquid crystal panel and the backlight source.

### BACKGROUND OF THE INVENTION

1. Field of the Invention

The present invention relates to the field of driving of liquid crystal displaying, and in particular to a clock driver of a large-sized liquid crystal display.

2. The Related Arts

A driving circuit of liquid crystal display comprises a timing control circuit, a source driving circuit, a gate driving circuit, and a backlight driving circuit.

Timing control is a necessary important component of a liquid crystal display and generally comprises a timing control circuit of which the functions are to receive a main board signal and to supply a gate driver timing signal, a source driver timing signal, and a data signal, a field synchronizing signal, and other function signals. Timing signals associated with gate driving include a clock signal (CKV), a start pulse signal (STV, which serves as a field synchronizing signal), an output enable signal (OE, which controls switching of the gate terminal). Timing signals associated with source driving includes a latch pulse signal (TP) and a polarity reversion signal (POL).

A backlight driving circuit uses the timing control signal and voltage/current signals to control the ON/OFF switching and darkening of a backlight source.

A liquid crystal screen usually has a refresh rate of 60 Hz, 120 Hz, 240 Hz, or even higher. The refresh rate indicates the number of frames that the liquid crystal screen can display in each second. The refresh rate is the same as STV signal. Besides being related to the liquid crystal screen itself, the displaying quality of a screen is also related to the backlight source. The backlight source often adopts PWM (Pulse Width Modulation) signals for dimming control, wherein the duty ratio of the PWM signal affects the luminance of the backlight source, while the PWM frequency affects the flicking of the screen.

Heretofore, tablet computers and liquid crystal displays both adopt independent adjustment of backlighting and the timing control circuit of the liquid crystal display screen and the timing control circuit of the backlight source are independent of each other with two chips separately controlling two timing sequences for gate driving and source driving. An additional central control processing module (MCU) is further included for control backlight driving clock. This arrangement cannot ensure consistency between the frequency of refresh rate of an LCD screen and the PWM frequency of the backlight control circuit, as well as consistency of phase, and may thus cause screen flicking. When the frame scanning frequency F₁ of liquid crystal display and the flicking frequency F₂ of the backlight source are synchronous and in phase, namely F₂=N·F₁, a phenomenon of stationary water ripple (wave standing) may occur and horizontal strips are shown stationary.

As shown in FIG. 1, particularly for large-sized liquid crystal displays, such as resolution being 3840×2160, the timing control of the liquid crystal display screen and the control of the backlight source are realized with two timing control chips (TCON), which respectively supply timing control signals for gate driving and source driving. Further an additional central control processing module (MCU) is further included for timing driving of the backlight source, in which timing driving is realized with high speed synchronous series communication (SPI) to generate PWM signals.

### SUMMARY OF THE INVENTION

An object of the present invention is to provide a clock driver of a liquid crystal display, wherein the controller comprises two timing control chips, of which one generates a source timing control signal and a gate timing control signal and also adopts a master/slave fashion to control another timing control chip to generate a PWM signal for backlight driving, so that the control chip that the known techniques requires for backlight scanning can be saved and the cost can thus be reduced.

To achieve the object, the present invention provides a clock driver of a liquid crystal display, which comprises a primary timing control chip, a secondary timing control chip electrically connected to the primary timing control chip and controlled by the primary timing control chip, display driving ports electrically connected to the primary and secondary timing control chips, a backlight driving port electrically connected to the secondary timing control chip, a first storage device electrically connected to the primary timing control chip, a second storage device electrically connected to the secondary timing control chip, and a data input port electrically connected to the primary and secondary timing control chips. The display driving ports function for electrical connection with a liquid crystal panel. The backlight driving port is electrically connectable with a backlight driving circuit. The primary and secondary timing control chips receive a control signal from the data input port and supply via the display driving port a display timing control signal and a display data signal to the liquid crystal panel according to the control signal. The secondary timing control chip supplies via the backlight driving port a pulse width modulation signal to the backlight driving circuit.

The first storage device comprises a FLASH storage device. The first storage device stores data for controlling image displaying.

The second storage device comprises a FLASH storage device. The second storage device stores data for controlling image displaying.

The signal that the primary and secondary timing control chips receive from the data input port comprises a primary low voltage differential signal.

The primary timing control chip and the secondary timing control chip take a same synchronization signal as reference to allow the two to simultaneously receive the primary low voltage differential signal and simultaneously transmit the display data signal and the display timing control signal to the display driving ports.

The synchronization signal is a start pulse signal generated by the primary timing control chip.

The primary timing control chip controls the secondary timing control chip in a high speed synchronous series communication based master/slave manner.

The display timing control signal is a secondary low voltage differential signal.

The display timing control signal comprises clock signal, start pulse signal, output enable signal, latch pulse signal, and polarity reversion signal.

The secondary timing control chip outputs eight pulse width modulation signals through the backlight driving port.

The present invention also provides a clock driver of a liquid crystal display, which comprises a primary timing control chip, a secondary timing control chip electrically connected to the primary timing control chip and controlled by the primary timing control chip, display driving ports electrically connected to the primary and secondary timing control chips, a backlight driving port electrically connected to the secondary timing control chip, a first storage device electrically connected to the primary timing control chip, a second storage device electrically connected to the secondary timing control chip, and a data input port electrically connected to the primary and secondary timing control chips, the display driving ports functioning for electrical connection with a liquid crystal panel, the backlight driving port being electrically connectable with a backlight driving circuit, the primary and secondary timing control chips receiving a control signal from the data input port and supplying via the display driving port a display timing control signal and a display data signal to the liquid crystal panel according to the control signal, the secondary timing control chip supplying via the backlight driving port a pulse width modulation signal to the backlight driving circuit;

wherein the first storage device comprises a FLASH storage device, the first storage device storing data for controlling image displaying;

wherein the second storage device comprise a FLASH storage device, the second storage device storing data for controlling image displaying;

the signal that the primary and secondary timing control chips receive from the data input port comprises a primary low voltage differential signal;

wherein the primary timing control chip and the secondary timing control chip take a same synchronization signal as reference to allow the two to simultaneously receive the primary low voltage differential signal and simultaneously transmit the display data signal and the display timing control signal to the display driving port;

wherein the synchronization signal is a start pulse signal generated by the primary timing control chip;

wherein the primary timing control chip controls the secondary timing control chip in a high speed synchronous series communication based master/slave manner;

wherein the display timing control signal is a secondary low voltage differential signal;

wherein the display timing control signal comprises clock signal, start pulse signal, output enable signal, latch pulse signal, and polarity reversion signal; and

wherein the secondary timing control chip outputs eight pulse width modulation signals through the backlight driving port.

The efficacy of the present invention is that the present invention provides a clock driver of a liquid crystal display that uses two timing control chips to respectively drive a liquid crystal panel and a backlight module, of which one timing control chip generates a source timing control signal and a gate timing control signal and also adopts a master/slave fashion to control another timing control chip to generate a pulse width modulation signal for backlight driving, so that the control chip that the known techniques requires for backlight scanning can be saved and the cost can thus be reduced and market competition power is improved.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing the structure of a conventional timing controller for liquid crystal display driving and backlight driving;

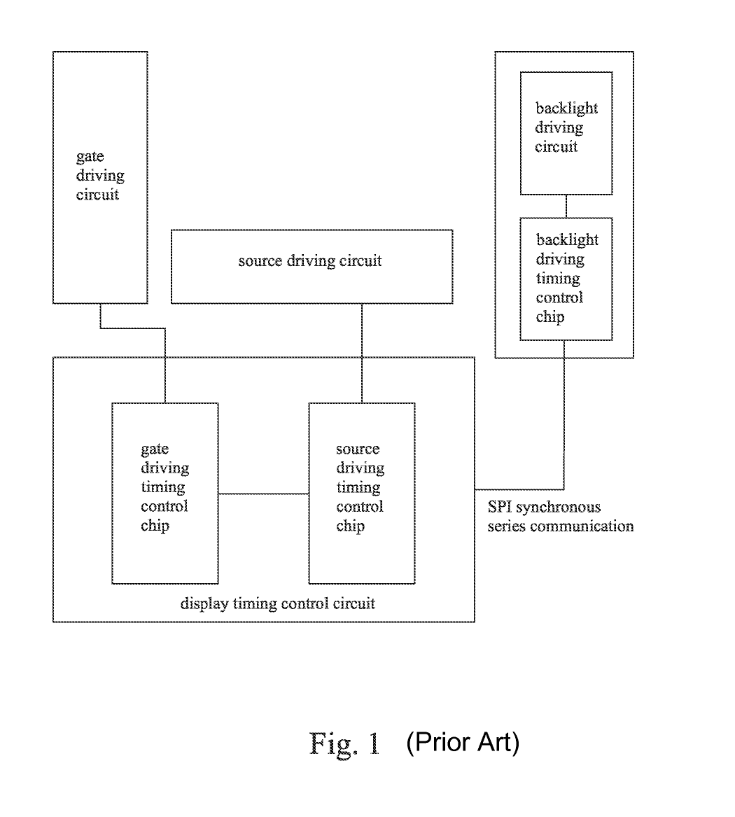

FIG. 2 is a schematic view showing the structure of a liquid crystal clock driver according to the present invention; and

FIG. 3 is a waveform diagram showing PWM signal generated by a timing control chip according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

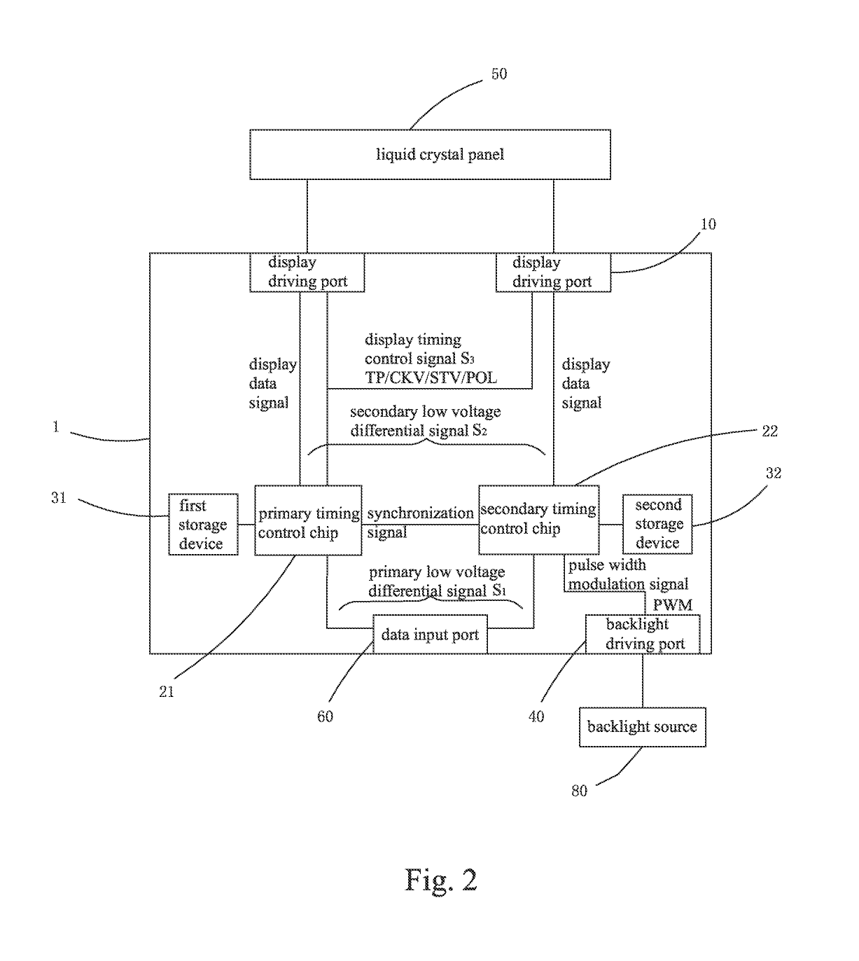

Referring to FIG. 2, the embodiment provides a liquid crystal display clock driver 1, which comprises a primary timing control chip 21, a secondary timing control chip 22 electrically connected to the primary timing control chip 21 and controlled by the primary timing control chip 21, display driving ports 10 electrically connected to the primary and secondary timing control chips 21, 22, a backlight driving port 40 electrically connected to the secondary timing control chip 22, a first storage device 31 electrically connected to the primary timing control chip 21, a second storage device 32 electrically connected to the secondary timing control chip 22, and a data input port 60 electrically connected to the primary and secondary timing control chips 21, 22. The display driving ports 10 function for electrical connection with a liquid crystal panel 50. The backlight driving port 40 is electrically connectable with a backlight driving circuit. The primary and secondary timing control chips 21, 22 receive a control signal from the data input port 60 and supply via the display driving port 10 a display timing control signal S₃ and a display data signal to the liquid crystal panel 50 according to the control signal and the secondary timing control chip 22 supplies via the backlight driving port 40 a pulse width modulation signal PWM to the backlight driving circuit, so that driving of the liquid crystal panel 50 and the backlight source 80 can be accomplished with two timing control chips. This saves the control chip MCU that is additionally included in the prior art device to carry out backlight scanning, thereby reducing the manufacture cost and improve market competition power.

The first storage device 31 comprises a FLASH storage device. The first storage device 31 functions to store data for controlling image displaying. The second storage device 32 comprises a FLASH storage device. The second storage device 32 functions to store data for controlling image displaying. These two provide fast speed of storage and elongated lifespan.

The data for controlling image displaying generally comprise: a master-slave communication control protocol and an operation control method between the primary timing control chip 21 and the secondary timing control chip 22. The master-slave communication control protocol comprises synchronous transmission, synchronous control information, and message of operations of each other with which the primary timing control chip 21 controls the secondary timing control chip 22. The communication control protocol further comprises the secondary timing control chip 22 and the primary timing control chip 21 synchronously receiving the signal on the data input port 60 and synchronously transmitting the display data signal and the display timing control signal S₃. The operation control method generally comprises operation and variation rules of the received data input port 60.

The primary timing control chip 21 and the secondary timing control chip 22 take the same synchronization signal as reference to allow the two to simultaneously receive the primary low voltage differential signal S₁ and simultaneously transmit the display data signal and the display timing control signal S₃ to the display driving port 10. The synchronization signal is a start pulse signal generated by the primary timing control chip 21. The start pulse signal that is generated by the primary timing control chip 21 is used to control the secondary timing control chip 22. The control that the primary timing control chip 21 makes over the secondary timing control chip 22 is a high speed synchronous series communication based master/slave manner. The high speed synchronous series communication ensures real time communication between the primary timing control chip 21 and the secondary timing control chip 22. Such a way of communication in combination with the start pulse signal achieve synchronization between the primary timing control chip 21 and the secondary timing control chip 22.

In the preferred embodiment, the signal that the primary and secondary timing control chips 21, 22 receive from the data input port 60 is a primary low voltage differential signal S₁. The display timing control signal is a secondary low voltage differential signal S₂.

The display timing control signal S₃ includes various signals, such as clock signal, start pulse signal, output enable signal, latch pulse signal, and polarity reversion signal.

The secondary timing control chip 22 outputs eight pulse width modulation signals PWM1-PWM8. The eight pulse width modulation signals PWM1-PWM8 are supplied through the backlight driving port 40 to output to the backlight driving circuit for driving the backlight source 80. The saves the control chip MCU that the prior art device needs for effecting backlight scanning and thus reduces the manufacture cost.

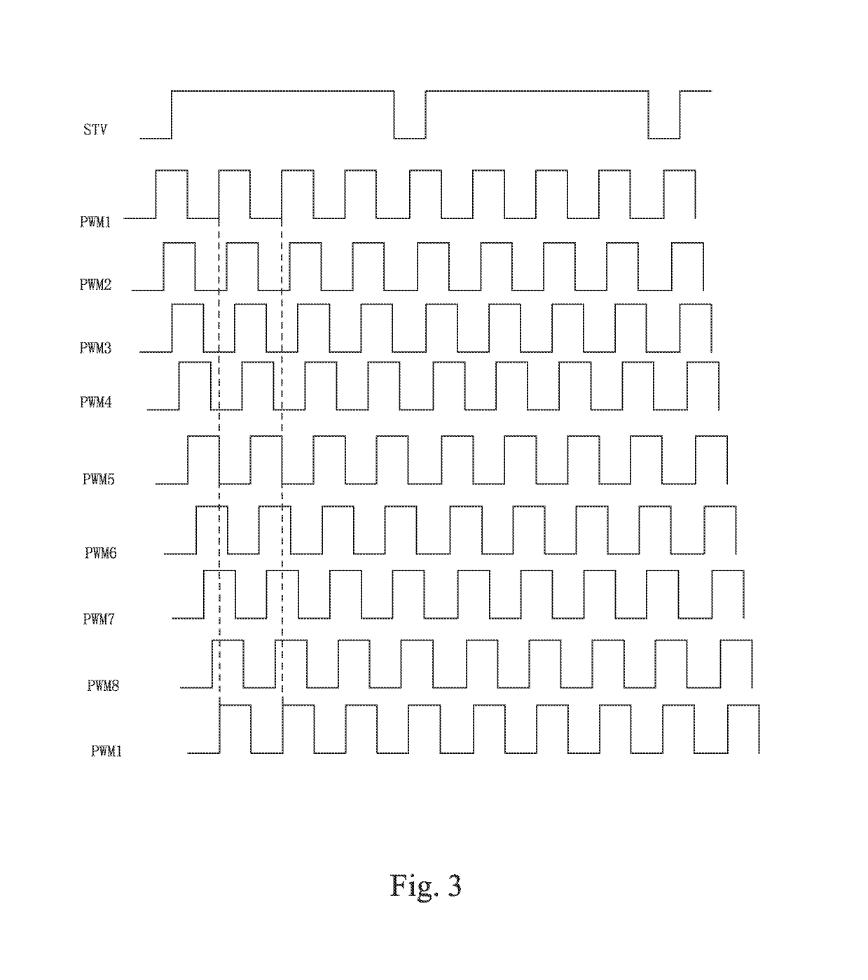

Referring to FIG. 3, in the preferred embodiment, preferably the secondary timing control chip 22 outputs eight pulse width modulation signals PWM1-PWM8 of which the starting phases are successively different from each other by 45 degrees, namely PWM1 (0°), PWM2 (45°), PWM3 (90°), PWM4 (135°), PWM5 (180°), PWM6 (225°), PWM7 (270°), and PWM8 (315°).

Further, the eight pulse width modulation signals PWM1-PWM8 can be simultaneously or successively and cyclically generated by the secondary timing control chip 22.

The timing controller 1 is applicable to a liquid crystal display having a resolution of 3840×2160.

The essential operation principle of the liquid crystal display clock driver 1 according to the present invention is as follows:

The primary timing control chip 21 and the secondary timing control chip 22 simultaneously receive the primary low voltage differential signal S₁ from the data input port 60. Next, the primary timing control chip 21 and the secondary timing control chip 22 respectively retrieve the master-slave communication control protocol and the operation control method stored in the first and second storage devices 31, 32. The primary timing control chip 21 follows the operation control method to generates a display timing control signals S₃ including a start pulse signal, an output enable signal, a latch pulse signal, a polarity reversion signal and generates, based on the received primary low voltage differential signal S₁, a display data signal including a secondary low voltage differential signal S₂. The primary timing control chip 21 transmits, at the same time, the start pulse signal and a control message of master/slave control manner to the secondary timing control chip 22 to allow the secondary timing control chip 22, which follows the retrieved master-slave communication control protocol and start pulse signal to operate in synchronization with primary timing control chip 21, to follow the control message of master/slave control manner, to operate with the primary timing control chip 21 in the master/slave manner. The secondary timing control chip 22 follows the retrieved operation control method and also follows the received primary low voltage differential signal S₁ to generate a display data signal such as the secondary low voltage differential signal S₂, and also generates eight pulse width modulation signals PWM1-PWM8 according to the start pulse signal.

The primary timing control chip 21 and the secondary timing control chip 22 transmit the display timing signal and the display data signal to the display driving port 10 to be further transmitted to the liquid crystal panel 50. The secondary timing control chip 22 transmits the eight pulse width modulation signals PWM1-PWM8 to the backlight driving port 40 to be further transmitted to the backlight source 80.

In summary, the present invention provides a liquid crystal display clock driver, which comprises a primary timing control chip and a secondary timing control chip that are electrically connected to each other and are operated in a high speed series communication based master/slave manner to simultaneously receive primary display data. The primary timing control chip generates display timing control message and generates, together with the secondary timing control chip, display data message. Further, the secondary timing control chip individually generates eight pulse width modulation signals for driving a backlight unit. These pulse width modulation signals are of phase difference with respect to each other and can be simultaneously or sequentially generated. Using these pulse width modulation signals to cyclically drive the backlight unit may overcome the standing wave phenomenon of liquid crystal displaying. The present invention may save the control chip that the prior art device needs for effecting backlight scanning and thus reduce the manufacture cost and improve market competition power.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A clock driver of a liquid crystal display, comprising a primary timing control chip, a secondary timing control chip electrically connected to the primary timing control chip and controlled by the primary timing control chip, display driving ports electrically connected to the primary and secondary timing control chips, a backlight driving port electrically connected to the secondary timing control chip, a first storage device electrically connected to the primary timing control chip, a second storage device electrically connected to the secondary timing control chip, and a data input port electrically connected to the primary and secondary timing control chips, the display driving ports functioning for electrical connection with a liquid crystal panel, the backlight driving port being electrically connectable with a backlight driving circuit, the primary and secondary timing control chips receiving a control signal from the data input port and supplying via the display driving port a display timing control signal and a display data signal to the liquid crystal panel according to the control signal, the secondary timing control chip supplying via the backlight driving port a pulse width modulation signal to the backlight driving circuit.

2. The clock driver of a liquid crystal display as claimed in claim 1, wherein the first storage device comprises a FLASH storage device, the first storage device storing data for controlling image displaying.

3. The clock driver of a liquid crystal display as claimed in claim 2, wherein the second storage device comprises a FLASH storage device, the second storage device storing data for controlling image displaying.

4. The clock driver of a liquid crystal display as claimed in claim 1, wherein the signal that the primary and secondary timing control chips receive from the data input port comprises a primary low voltage differential signal.

5. The clock driver of a liquid crystal display as claimed in claim 4, wherein the primary timing control chip and the secondary timing control chip take a same synchronization signal as reference to allow the two to simultaneously receive the primary low voltage differential signal and simultaneously transmit the display data signal and the display timing control signal to the display driving ports.

6. The clock driver of a liquid crystal display as claimed in claim 5, wherein the synchronization signal is a start pulse signal generated by the primary timing control chip.

7. The clock driver of a liquid crystal display as claimed in claim 6, wherein the primary timing control chip controls the secondary timing control chip in a high speed synchronous series communication based master/slave manner.

8. The clock driver of a liquid crystal display as claimed in claim 5, wherein the display timing control signal is a secondary low voltage differential signal.

9. The clock driver of a liquid crystal display as claimed in claim 8, wherein the display timing control signal comprises clock signal, start pulse signal, output enable signal, latch pulse signal, and polarity reversion signal.

10. The clock driver of a liquid crystal display as claimed in claim 1, wherein the secondary timing control chip outputs eight pulse width modulation signals through the backlight driving port.

11. A clock driver of a liquid crystal display, comprising a primary timing control chip, a secondary timing control chip electrically connected to the primary timing control chip and controlled by the primary timing control chip, display driving ports electrically connected to the primary and secondary timing control chips, a backlight driving port electrically connected to the secondary timing control chip, a first storage device electrically connected to the primary timing control chip, a second storage device electrically connected to the secondary timing control chip, and a data input port electrically connected to the primary and secondary timing control chips, the display driving ports functioning for electrical connection with a liquid crystal panel, the backlight driving port being electrically connectable with a backlight driving circuit, the primary and secondary timing control chips receiving a control signal from the data input port and supplying via the display driving port a display timing control signal and a display data signal to the liquid crystal panel according to the control signal, the secondary timing control chip supplying via the backlight driving port a pulse width modulation signal to the backlight driving circuit;
wherein the first storage device comprises a FLASH storage device, the first storage device storing data for controlling image displaying;
wherein the second storage device comprise a FLASH storage device, the second storage device storing data for controlling image displaying;
the signal that the primary and secondary timing control chips receive from the data input port comprises a primary low voltage differential signal;
wherein the primary timing control chip and the secondary timing control chip take a same synchronization signal as reference to allow the two to simultaneously receive the primary low voltage differential signal and simultaneously transmit the display data signal and the display timing control signal to the display driving port;
wherein the synchronization signal is a start pulse signal generated by the primary timing control chip;
wherein the primary timing control chip controls the secondary timing control chip in a high speed synchronous series communication based master/slave manner;
wherein the display timing control signal is a secondary low voltage differential signal;
wherein the display timing control signal comprises clock signal, start pulse signal, output enable signal, latch pulse signal, and polarity reversion signal; and
wherein the secondary timing control chip outputs eight pulse width modulation signals through the backlight driving port.
